(19) United States
(12) Patent Application Publication
(10) Pub. No.: US 2009/0037963 A1
(43) Pub. Date: Feb. 5, 2009

(54) SYSTEM FOR ELECTRONIC RETAIL SALES OF MULTI-MEDIA ASSETS

(75) Inventors: Thomas J. Murray, Longmont, CO (US); David L. McGovern, Superior, CO (US)

Correspondence Address: PATTON BOGGS LLP, 1801 CALFORNIA STREET, SUITE 4900, DENVER, CO, 80202, US

(73) Assignee: YouBiquity, LLC, Superior, CO (US)

(21) Appl. No.: 12/176,064

(22) Filed: Jul. 18, 2008

Related U.S. Application Data
(63) Continuation-in-part of application No. 12/057,881, filed on Mar. 28, 2008.
Application No. 12/057,881 is a continuation-in-part of application No. 12/058,002, filed on Mar. 28, 2008.
Application No. 12/058,002 is a continuation-in-part of application No. 12/058,106, filed on Mar. 28, 2008.
Application No. 12/058,106 is a continuation-in-part of application No. 12/058,332, filed on Mar. 28, 2008.
Application No. 12/058,332 is a continuation-in-part of application No. 12/058,434, filed on Mar. 28, 2008.
(60) Provisional application No. 60/953,527, filed on Aug. 2, 2007.
(60) Provisional application No. 60/953,996, filed on Aug. 4, 2007.
(60) Provisional application No. 60/953,995, filed on Aug. 4, 2007.

(51) Int. Cl. H04N 7/173

(52) U.S. Cl. 725/92

(57) ABSTRACT

The system for electronic retail sales of multi-media assets operates as an overlay application on existing multi-media communication networks to receive individual consumer purchase requests for a selected multi-media asset and deliver a copy of that multi-media asset to the consumer's designated online personal storage space, which represents a network-based consumer multi-media library. In addition, the network-based consumer multi-media library enables the consumer to store consumer generated multi-media assets. The consumer can then access the contents of their network-based consumer multi-media library at any desired time and place, with the consumer selected multi-media asset being delivered to the requesting consumer in a mode appropriate for the consumer's communication device over the multi-media communication network that serves the consumer's presently active communication device.

### CROSS-REFERENCE TO RELATED APPLICATIONS

This application is a utility filing which claims priority to U.S. Provisional Application No. 60/953527, filed Aug. 2, 2007 and titled “Method And System For On-Demand Television Network”; U.S. Provisional Application No. 60/953995, filed Aug. 4, 2007 and titled “Method And System For Electronic Retail Sales Of Video On Demand Assets”; and U.S. Provisional Application No. 60/953996, filed Aug. 4, 2007 and titled “Method And System For Allocating Mass Storage For Video On Demand Assets”. This application also is a Continuation-In-Part of U.S. patent application Ser. No. 12/057881 filed on Mar. 28, 2008 and titled “Electronic Content Asset Publication System”; U.S. patent application Ser. No. 12/058002 filed on Mar. 28, 2008 and titled “System For Managing Distributed Assets In An Electronic Content Asset Publication System”; U.S. patent application Ser. No. 12/058106 filed on Mar. 28, 2008 and titled “System For Distributing Electronic Content Assets Over Communication Media Having Differing Characteristics”; U.S. patent application Ser. No. 12/058332 filed Mar. 28, 2008 and titled “User Interface Architecture For An Electronic Content Asset Publication System”; and U.S. patent application Ser. No. 12/058434 filed Mar. 28, 2008 and titled “Personal Content Archive Operable In An Electronic Content Asset Publication System”. This application also is related to the U.S. Patent Application titled “System For Allocating Mass Storage For Video-On-Demand Assets” and filed concurrently herewith. The entire disclosures of each application are incorporated herein by reference.

### FIELD OF THE INVENTION

This invention relates to multi-media communication networks and to a system that is operable in these multi-media communication networks to electronically retail multi-media assets to consumers and to provide ubiquitous access to these multi-media assets to the consumers, where the multi-media assets include consumer generated multi-media assets.

### BACKGROUND OF THE INVENTION

It is a problem in multi-media entertainment that multi-media assets, such as movies, documentaries and television series, are presently sold to consumers on physical media, such as DVDs, through retail operations, including traditional brick-and-mortar retailers and online retailers. The consumer stores the purchased physical media in a “home multi-media library” and can then play their owned multi-media assets, as desired, on a multi-media player. In addition, the various physical media can be transported by the consumer to other locations, for viewing on a selected multi-media player at that location, or on a portable multi-media player as the consumer is traveling.

However, the management of the home multi-media library suffers from the inability of the consumer to access its contents from remote locations. The consumer must transport selected physical media if they are to be viewed at remote locations or must upload the contents of a limited number of physical media to a portable storage device which is then transported to the remote location. This provides only limited and static access to the contents of the home multi-media library and dynamic access to the entire contents of the home multi-media library is not presently an option. Recently emerging online video rental services from service providers such Netflix, Inc. and Apple, Inc. use set-top equipment to download or stream content from the service provider's multi-media library over an Internet connection. Consumers of these online rental services cannot purchase any of this content to own it outright. Rented content is only available temporarily and separately from the consumer's home multi-media library and is only accessible via the service provider's set-top equipment. Furthermore, the Internet connection requirement limits the portability of these services.

In a related field, there are a number of existing multi-media communication networks that serve to provide a consumer with access to selected mass media content sources. These multi-media communication networks include the Public Switched Telephone Network (“PSTN”), cellular communications systems, the Internet, Cable Television (“CATV”) systems, Satellite communication systems and the like. These various multi-media communication networks each provide a specific communication medium that is used to deliver mass media content to the consumer from predetermined mass media content sources. These mass media content sources can be broadcast stations (such as cable television channels) that transmit a stream of multi-media files (programs) to consumers or can be media repositories (such as a website or a video on demand system) that deliver mass media content to the consumer upon receipt of a request from the consumer.

A third category of content is the consumer-generated multi-media asset, which is not available to the general public and is available either to only the consumer who generated the multi-media asset or to a selected group of individuals who are authorized by the consumer to access the consumer generated multi-media asset. These consumer generated multi-media assets are presently stored in the home multi-media library or on the consumer's computer system.

In these existing multi-media storage paradigms, the home multi-media library and the multi-media communication networks represent two mutually exclusive and incompatible multi-media asset sources, since the multi-media communication networks traditionally present television network programming (including broadcast, cable, satellite, etc.) according to a linear channel model, where the channel content and the broadcast schedule are immutable and are set by the television network. Some mass media content sources can transmit a stream of multi-media files (programs) to consumers or can be multi-media asset repositories (such as a website or a video on demand system) that deliver video assets to the consumer upon receipt of a request from the consumer. However, the mass media content sources are not sufficiently extensive to include all of the video assets that are present in the consumer's home multi-media library and the mass media content sources do not enable the consumer to purchase a selected video asset. Furthermore, these mass media content sources do not provide access to consumer generated multi-media assets.

Therefore, there is presently no system which electronically retails multi-media assets to consumers and provides ubiquitous access to these multi-media assets to the consumers, which multi-media assets include consumer generated multi-media assets.

### BRIEF DESCRIPTION OF THE INVENTION

The above-described problems are solved and a technical advance is achieved in the field by the present System For Electronic Retail Sales of Multi-Media Assets (termed “E-Multi-Media Asset Sale System” herein) which operates as an overlay application on existing multi-media communication networks to receive individual consumer requests for a selected multi-media asset and deliver a copy of that multi-media asset to the consumer's designated online personal storage space, which represents a network-based consumer multi-media library. In addition, the network-based consumer multi-media library enables the consumer to store consumer generated multi-media assets. The consumer can then access the contents of their network-based consumer multi-media library at any desired time and place, with the consumer selected multi-media asset being delivered to the requesting consumer in a mode appropriate for the consumer's communication device over the multi-media communication network that serves the consumer's presently active communication device. The E-Multi-Media Asset Sale System is therefore substantially medium agnostic, enabling consumers to purchase a selected multi-media asset and also to access that purchased multi-media asset without the limitation of predetermined content transmission mediums, modes, and times.

The E-Multi-Media Asset Sale System provides a portal to existing multi-media communication networks and offers on-demand access to the contents of the consumer's network-based consumer multi-media library. In this way, the E-Multi-Media Asset Sale System provides a system for electronically retailing and leasing multi-media assets to consumers, thereby reducing or perhaps eliminating the need to manufacture, distribute and retail these assets on physical media in the retail marketplace. The E-Multi-Media Asset Sale System electronically deposits purchased or leased multi-media assets in the network-based consumer multi-media library where these assets are accessible for playback on demand. This E-Multi-Media Asset Sale System also implements a method by which consumers who have already purchased multi-media assets on physical media can electronically gain multi-media on demand access to those multi-media assets. The E-Multi-Media Asset Sale System may be implemented within the Multi-Media Asset Publication System of the above-listed parent patent applications, or it may be implemented outside of such a system using the present definition as a reference description. When implemented within the Multi-Media Asset Publication System, a consumer of this system may view their purchased or leased assets on demand, anywhere, anytime, on any device. Without loss of generality, the E-Multi-Media Asset Sale System is herein presented of convenience in the context of the Multi-Media Asset Publication System. New terminology defined herein will cross-reference any equivalent terminology defined in the above-listed parent patent applications, and such new and equivalent terminology herein will be used interchangeably.

### BRIEF DESCRIPTION OF THE DRAWINGS

FIG. 1 illustrates, in block diagram form, the overall architecture of a multi-media communication network which implements a number of communication technologies, and which includes the present E-Multi-Media Asset Sale System;

FIG. 2 illustrates a simplified diagram of the present E-Multi-Media Asset Sale System;

FIG. 3 illustrates, in flow diagram form, the operation of the E-Multi-Media Asset Sale System in the publishing of a Multi-Media Asset;

FIG. 4 illustrates in flow diagram form, the operation of the present E-Multi-Media Asset Sale System; and

FIGS. 5A and 5B illustrate, in block diagram form, typical centralized and distributed Publisher/Subscriber database architectures where the database is shared among multiple operators.

### DETAILED DESCRIPTION OF THE INVENTION

The present E-Multi-Media Asset Sale System is operable in multi-media communication networks to electronically retail, lease, and register multi-media assets to consumers and to provide ubiquitous access to these multi-media assets to the consumers.

### Definitions

Multi-Media Asset. A Multi-Media Asset is any machine readable, pre-recorded digital multi-media content such as a movie, television series episode, sports event, music, text, graphics, etc. A Content Owner holds the Multi-Media Asset copyright. A Retail Operator may electronically sell, lease or register a Multi-Media Asset to a Consumer on behalf of a Content Owner. A Storage Operator may store a Multi-Media Asset in a Network-Based Consumer Multi-Media Library on behalf of a Consumer. A Multi-Media on Demand Operator may retransmit a Multi-Media Asset, held by a Storage Operator in a Network-Based Consumer Multi-Media Library, on behalf of a Consumer. A Consumer may view a Multi-Media Asset on demand as authorized by a Content Owner or by another Consumer. In the Multi-Media Asset Publication System, a Multi-Media Asset is called an Electronic Content Asset, Subscriber Asset, Distinct Asset, or Local Asset.

Multi-Media Asset Entitlement. A Multi-Media Asset Entitlement is a machine readable digital conveyance, such as a digital license certificate, that uniquely identifies a particular Consumer and a particular Multi-Media Asset purchased, leased, or registered by that Consumer. The Content Owner or the Retail Operator may define the Multi-Media Asset Entitlement format or content.

Consumer. A Consumer electronically purchases or leases a Multi-Media Asset from a Retail Operator or electronically registers a physical Multi-Media Asset via a Retail Operator, and may view these Multi-Media Assets on demand via cable television, satellite television, IPTV, the Internet or on any web-enabled devices including personal computers, cell phones, PDAs, etc. A Content Owner may authorize a Consumer to purchase, lease, register, possess, store, transmit, retransmit, share and view a Multi-Media Asset per the terms of sale. In the Multi-Media Asset Publication System, a Consumer is called a subscriber or a Subscriber.

Network-Based Consumer Multi-Media Library. A Consumer may own or lease one or more Network-Based Consumer Multi-Media Libraries to store electronically-purchased, leased or registered Multi-Media Assets acquired by or accessible to the Consumer. The collection of Network-Based Consumer Multi-Media Libraries held by a Consumer may be stored by a single Storage Operator or by multiple Storage Operators. In the Multi-Media Asset Publication System, a Network-Based Consumer Multi-Media Library is called a Personal Video Archive, a Subscriber Library, or a Video on Demand Library.

Storage Operator. A Storage Operator provides digital Multi-Media Asset Storage facilities to Consumers for Network-Based Consumer Multi-Media Libraries. A Content Owner may authorize a Storage Operator to store Multi-Media Assets electronically purchased, leased or registered by Consumers. A Storage Operator electronically receives a Multi-Media Asset or a Multi-Media Asset Entitlement from a Retail Operator and deposits it in a Network-Based Consumer Multi-Media Library designated by the Consumer. A Storage Operator may provide access to the Network-Based Consumer Multi-Media Library to Content Owners, Retail Operators, Multi-Media on Demand Operators, Consumers or other Storage Operators. A Storage Operator may be a commercial data center operator, an Internet Service Provider (ISP), an online storage provider, a television head-end or super head-end operator, etc. In the Multi-Media Asset Publication System, a Storage Operator may be a Video Content Host Site operator or an All Video On-Demand Network operator.

Multi-Media on Demand Operator. A Multi-Media on Demand (MMoD) Operator utilizes its multi-media on demand distribution facilities to deliver a Multi-Media Asset from a Network-Based Consumer Multi-Media Library to the Consumer that purchased, leased or registered it, or to a Consumer who has acquired access privileges for that Multi-Media Asset. A Content Owner may authorize a Multi-Media on Demand Operator to retransmit Multi-Media Assets stored in Network-Based Consumer Multi-Media Libraries to Consumers on demand. Multi-Media on Demand Operators include cable, satellite, IPTV, and Internet-based operators. In the Multi-Media Asset Publication System, a Multi-Media on Demand Operator is called an operator or a video on demand operator and may be a Video Content Host Site operator or an All Video On-Demand Network operator.

Content Owner. A Content Owner holds the Multi-Media Asset copyright and may assign certain rights to other entities, for example the right to possess, store, transmit, retransmit, share, register, purchase, lease or sell retail copies of a Multi-Media Asset.

Retail Operator. A Retail Operator electronically sells, leases, or registers Multi-Media Assets to Consumers, typically over the Internet. A Content Owner may authorize a Retail Operator to conduct these transactions, which may convey certain rights to Consumers. A Retail Operator may provide a Consumer with a Bill of Sale detailing the transaction. A Retail Operator electronically ships each purchased, leased or registered Multi-Media Asset, or an associated Multi-Media Asset Entitlement, to a Storage Operator designated by the Consumer; or electronically deposits these Multi-Media Assets or Multi-Media Asset Entitlements in personal Multi-Media Asset Storage designated by the Consumer. In the Multi-Media Asset Publication System, a Retail Operator may be a Video Content Host Site operator or an All Video On-Demand Network operator.

Multi-Media Asset Storage. Multi-Media Asset Storage is any suitable long-term digital storage media for Multi-Media Assets and Network-Based Consumer Multi-Media Libraries. A Multi-Media Asset Storage facility may utilize a hierarchical storage system comprising a collection of different types of storage media and control software that implements the storage hierarchy.

Bill of Sale. A Bill of Sale is an itemized receipt in hardcopy or electronic document format, e.g., e-mail, which records an electronic Multi-Media Asset sale, lease or registration transaction conducted between a Retail Operator and a Consumer. The Bill of Sale details the transaction and includes a list of the Multi-Media Assets sold, leased or registered, along with specific information describing each Multi-Media Asset, e.g., title, format, etc.

### Multi-Media Communication Network Examples

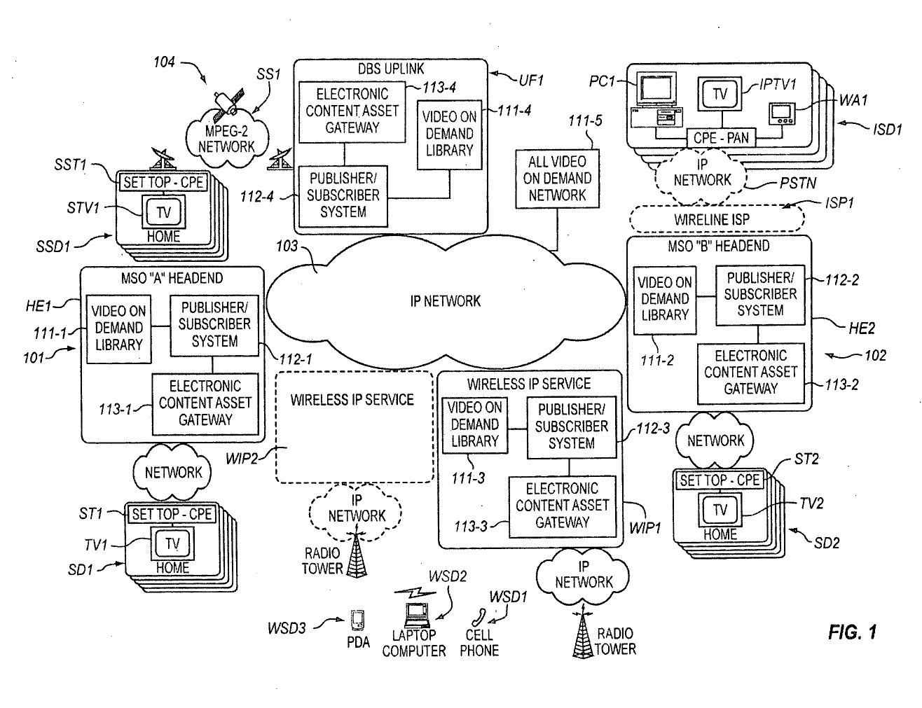

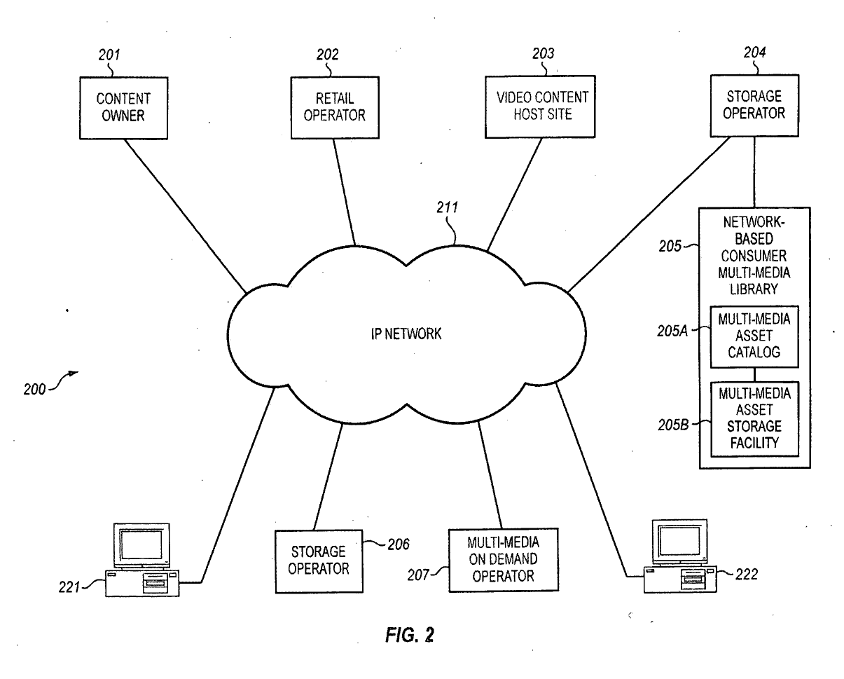

FIG. 1 illustrates, in block diagram form, the overall architecture of a multi-media communication network which implements a number of communication technologies, and which includes various elements of the present E-Multi-Media Asset Sale System (which is shown in FIG. 2). This view of multi-media communication networks is at a conceptual level, where the specific implementation details are omitted for the sake of clarity. A typical multi-media communication network comprises a plurality of physical elements to implement the communication mediums and associated signal distribution control systems. These functions are simply illustrated as the “Network” that interconnects and serves Consumer devices and Multi-Media Asset sources. Note that today these networks are not interoperable for multi-media content distribution among all network nodes.

Examples of such multi-media communication networks include a Cable Television Network 101 and 102 that interconnects a plurality of Consumer devices SD1 and SD2, each comprising a television set TV1 and TV2 and its associated “set-top box” ST1 and ST2, with the program source comprising a Master System Operator head-end HE1 and HE2 that receives program content from various sources and delivers the program content to Consumers via a plurality of concurrently broadcast channels. The Master System Operator head-end HE1 and HE2 is also shown as interconnected with the Internet 103. A Satellite Television Network 104 interconnects a plurality of Consumer devices SSD1, each comprising a television set STV1 and its associated “set-top box” SST1, with the program source comprising a Master System Operator uplink facility UF1 that receives program content from various sources and delivers the program content to Consumers via a satellite system SS1 that transmits a plurality of concurrently broadcast channels. The Master System Operator uplink facility UF1 is also shown as interconnected with the Internet 103. Another multi-media communication network comprises a wire-line Internet Service Provider ISP1 that interconnects Consumer devices ISD1, such as personal computers PC1, IP Televisions IPTV1, other appliances WA1, with a program source via the Public Switched Telephone Network PSTN. The Internet Service Provider ISP1 may provide program content or simply interconnect the Consumer device with an entity, also served by the Internet 103, which contains the program content. A variation of the wire-line Internet Service Provider ISP1 is a wireless IP Service WIP1 and WIP2 that interconnects portable Consumer devices, WSD1-WSD3 such as cellular telephones WSD1, personal computers WSD2, PDAs, and WSD3 and the like, with a program source via the Cellular Telephone Network. The wireless IP Service Provider ISP1 and ISP2 may provide program content or simply interconnect the Consumer device with an entity, also served by the Internet 103, which contains the program content.

Connected to the multi-media communication networks, either directly or via the Internet 103, are a plurality of elements (typically distributed) that operate to implement the present E-Multi-Media Asset Sale System in a multi-media communication network. These elements include a Publisher/Subscriber System component 112-1 to 112-4 that functions to register published Multi-Media Assets. In addition, Publisher/Subscriber System component 112-1 to 112-4 uses the Consumer (subscriber) unambiguous identity credentials and the Multi-Media Asset Identifier to determine whether a Consumer is authorized to access a Multi-Media Asset, and to initiate delivery of that Multi-Media Asset to the Consumer via a multi-media communication medium. The Publisher/Subscriber System component 112-1 to 112-4 may also include an entity that promotes a standardized method for rating content and establishing its appropriateness for particular classes of Consumers, and for authorizing or denying Multi-Media Asset access based on those ratings or classifications and the Consumer's class membership. Certain Multi-Media Assets are stored in various locations in this multi-media communication network and these are noted as Video on Demand Libraries 111-1 to 111-4, which are located in the various multi-media communication networks noted above. Certain other Multi-Media Assets such as live feeds or live streams are distributed within this multi-media communication network and might not be stored anywhere in this multi-media communication network. In addition, All Video On Demand Network 111-5 is shown as connected to the Internet and functions to provide multi-media on demand content and personalized Consumer services to the various multi-media communication networks noted above. Finally, Electronic Content Asset Gateway component 113-1 to 113-4 is shown and includes various multi-media communication network intercommunication and media translation functions as described below. These elements collectively operate with the existing multi-media communication networks and comprise the present E-Multi-Media Asset Sale System.

The E-Multi-Media Asset Sale System acquires, stores, publishes, distributes, accesses, and processes Multi-Media Assets on demand and over a multi-media communications infrastructure. The E-Multi-Media Asset Sale System for example, enables Consumers to access multi-media content for viewing on a conventional television set or a suitable Web-Enabled Device (WED), e.g., a personal computer, a PDA or a cell phone.

The E-Multi-Media Asset Sale System also provides the capability for the Consumer to permit others to access their personal Multi-Media Assets on a television set or a WED device. Consumers may access Multi-Media Assets for viewing at the same physical location where the Multi-Media Assets originate, or for viewing from a remote location, perhaps one situated at a great distance from the origin site.

### Publisher/Subscriber (P/S) Model

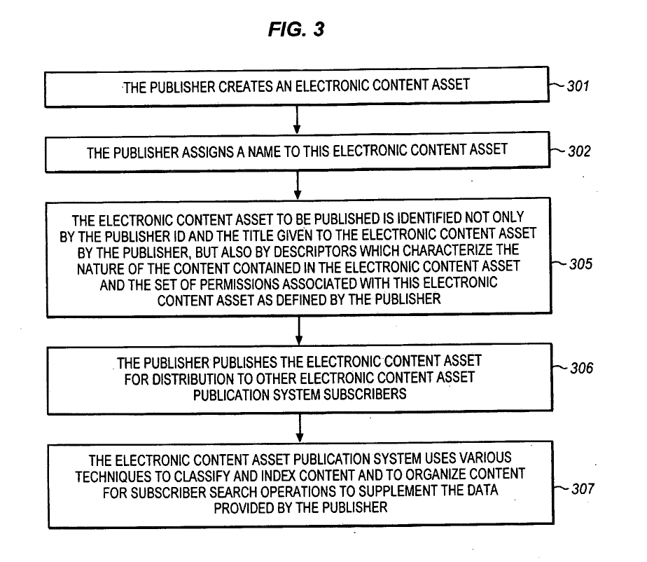

FIG. 3 illustrates, in flow diagram form, the operation of the E-Multi-Media Asset Sale System in the publishing of a Multi-Media Asset. In order to understand the ubiquity and diversity of the Multi-Media Assets and their management, a Publisher/Subscriber (P/S) model is used to define the Content On-Demand content ubiquity aspect of the E-Multi-Media Asset Sale System. The Publisher/Subscriber model logically provides a virtual multi-media canvas upon which a subscriber (Consumer), who is called a Publisher, may prepare or compose a Multi-Media Asset for publication. Such Multi-Media Asset preparation or composition processes may specify a layout format which may be a tiled format, picture-in-picture format or any other format, and which may indicate the layout format in which the Multi-Media Asset should be rendered for viewing on a subscriber multi-media device. The example used herein to illustrate this concept is the creation of a Multi-Media Asset from one or more live or recorded camera feeds (each feed is one or several camera feeds combined as one feed) and/or Multi-Media Asset Metadata sources as defined below. The Publisher creates this Multi-Media Asset at step 301, assigns a name to this Multi-Media Asset at step 302 and publishes the Multi-Media Asset for distribution to other E-Multi-Media Asset Sale System subscribers at step 306, who are called Authorized Subscribers. The Publisher/Subscriber system at step 305 may assign descriptors that indicate a content rating for the published Multi-Media Asset or the appropriateness for access by particular classes of subscribers. The Publisher/Subscriber system may subsequently authorize or deny Multi-Media Asset access based on these ratings or classifications and the subscriber's class membership. An Authorized Subscriber may access a Multi-Media Asset on demand, in accordance with the terms of publication associated with this Multi-Media Asset. The E-Multi-Media Asset Sale System logically publishes each such created Multi-Media Asset to the Multi-Media Asset's own Publisher with no restrictions on its use; hence the Publisher/Subscriber model logically applies uniformly to all Multi-Media Assets within the present E-Multi-Media Asset Sale System. The Publisher of a Multi-Media Asset may update any characteristics of the published Multi-Media Asset at any time.

A Publisher may use E-Multi-Media Asset Sale System interactive design tools or layout tools to specify the composition, layout or format of one or more Multi-Media Assets comprising a new Multi-Media Asset including the placement or location of individual Multi-Media Assets upon the virtual layout canvas; or to specify the Multi-Media Assets to be used as backgrounds, wallpapers, borders, window frames, colors, fonts, graphics, icons; or to specify any other layout or design elements or resources, etc. A Multi-Media Asset composition or layout may also specify interactive features, renderings, animations, etc. For example, a Publisher may compose a Multi-Media Asset that is a collection of other Multi-Media Assets that are digital image files; next, the Publisher may layout this composed Multi-Media Asset in a window placed at a particular location on the virtual canvas and may specify the Multi-Media Asset shall be rendered or animated for viewing as a cyclic linear progression of its individual underlying Multi-Media Asset digital image files. Multi-Media Asset composition and layout data or metadata specified by the Publisher is stored in Publisher/Subscriber database entries describing the published Multi-Media Asset. Multi-Media Asset composition data or metadata may include the name or address of each multi-media stream or file comprising a published Multi-Media Asset. For example, Multi-Media Asset composition data or metadata may indicate the multi-media network address of a live stream, or the name and multi-media network address of a Video on Demand Library along with the name of a multi-media file stored in that Video on Demand Library.

The Publisher/Subscriber model defines a secure one-to-many subscription relationship that limits access to each Multi-Media Asset to a specified Authorized Subscriber base. Further, the publication process establishes a set of publication terms-of-use that may include, but are not limited to, republication rights, scheduled availability, medium access rights, device access rights, and so on. Re-publication terms-of-use establish whether or not an Authorized Subscriber has the right to re-publish a Multi-Media Asset to other Authorized Subscribers, with optional limits on the breadth and depth of the re-publication privilege for the Multi-Media Asset. Schedule terms-of-use allow the Publisher to specify when a Multi-Media Asset may be accessed, including, but not limited to, start date/time and duration, expiration date/time, recurrence frequency, and so on. Medium access rights terms-of-use define the multi-media communication medium(s) from which a published Multi-Media Asset may be accessed, e.g., the public Internet, cable television network, wireless network and any other multi-media communication mediums. Device access rights terms-of-use define the multi-media device(s) from which a published Multi-Media Asset may be viewed, e.g., cell phones, PDAs, Personal Computers, cable TVs, satellite TVs, IPTV and any other multi-media devices. A Publisher may selectively revoke subscription rights to a selected Multi-Media Asset at any time. The revocation of subscription rights may recursively expunge all republished instances of the selected Multi-Media Asset. An Authorized Subscriber may unsubscribe from a Multi-Media Asset at any time.

Re-publication relationships may be private, semi-private or public. A private republication relation limits Multi-Media Asset access to the Authorized Subscribers who are assigned subscription rights firsthand by the Publisher, i.e., all re-publication rights to the Multi-Media Asset are disallowed. A semi-private re-publication relation limits re-publication capabilities; for example, it allows each firsthand Authorized Subscriber to optionally re-publish the Multi-Media Asset to only one other Authorized Subscriber. A public re-publication relation grants access to the Multi-Media Asset to every subscriber. All publication terms-of-use may apply to all three republication relations including schedule terms-of-use, medium access rights terms-of-use and device access rights terms-of-use.

### Subscriber Unambiguous Identity Credentials

Every subscriber (Consumer), including every Publisher and every Authorized Subscriber, must have an unambiguous identity within the present E-Multi-Media Asset Sale System. The present E-Multi-Media Asset Sale System may use an identity-agnostic scheme for authenticating subscriber unambiguous identity credentials, for example a scheme where subscriber unambiguous identity credentials are issued and authenticated by one or more Video Content Host Site operators or by other entities operating beyond the present E-Multi-Media Asset Sale System; other forms of subscriber unambiguous identity credentials are possible. An illustrative example used herein of a subscriber unambiguous identity credential is a fully-qualified E-mail address of the form “username domainname” together with the password for that E-mail account, both of which are registered with one of the Video Content Host Site operators within the present E-Multi-Media Asset Sale System. If a subscriber has unambiguous identity credentials registered with more than one Video Content Host Site operator in an E-Multi-Media Asset Sale System, or registered with more than one other entity operating beyond the present E-Multi-Media Asset Sale System, the subscriber is said to have unambiguous identity aliases, and each such alias unambiguously identifies the subscriber within the present E-Multi-Media Asset Sale System. A Publisher publishes a Multi-Media Asset by specifying the unambiguous identities and any unambiguous identity aliases of one or more Authorized Subscribers who may access that Multi-Media Asset. In the illustrative example used herein, the Publisher specifies one or more fully-qualified E-mail addresses for each Authorized Subscriber permitted to access a published Multi-Media Asset. The unambiguous identities and unambiguous identity aliases specified by a Publisher are stored in Publisher/Subscriber database Authorized Subscriber entries describing the published Multi-Media Asset and are known collectively as the Authorized Subscriber List for that Multi-Media Asset.

An Authorized Subscriber must present an unambiguous identity or an unambiguous identity alias as identity credentials for accessing a Multi-Media Asset. For Multi-Media Asset access from a WED device, an Authorized Subscriber uses GUI-WED or GUI-WEB to sign on from a WED device and then declare an unambiguous identity or any unambiguous identity aliases to be used for accessing Multi-Media Assets during that sign-on session. Video Content Host Site identity credential authentication software should authenticate these identity credentials before the Authorized Subscriber may use these identity credentials to access any Multi-Media Assets. Video Content Host Site identity credential authentication software may, for example, require an Authorized Subscriber to enter the password for each fully-qualified E-mail address listed as an unambiguous identity or unambiguous identity alias, and Video Content Host Site identity credential authentication software may contact the “domainname” site specified as a part of each E-mail address to verify that the given password for “username@domainname” is a valid password. Other forms of Authorized Subscriber identity credential authentication are possible.

For Multi-Media Asset access from a cable television set, an Authorized Subscriber presents unambiguous identity or unambiguous identity alias credentials to the cable operator which is functioning as a Video Content Host Site operator. The cable operator may establish a default Authorized Subscriber unambiguous identity by matching the serial number or other unique data obtained from the Authorized Subscriber's set-top box or equivalent cable receiver device with the Authorized Subscriber's cable account information held on file. An Authorized Subscriber may supply any unambiguous identity or unambiguous identity aliases via a Multi-Media Asset Publication System interactive program guide menu or screen, which may be a GUI-IPG menu or screen. An Authorized Subscriber may also “sign off” of the E-Multi-Media Asset Sale System from a cable television set so that another Authorized Subscriber may sign on from the same cable television set to supply his or her own unambiguous identity credentials. E-Multi-Media Asset Sale System identity credential authentication software hosted by the cable operator which is functioning as a Video Content Host Site operator should authenticate all Authorized Subscriber identity credentials before the Authorized Subscriber may use those identity credentials to access any Multi-Media Assets. The cable operator's identity credential authentication method may be the same method described herein to authenticate Authorized Subscriber identity credentials for Multi-Media Asset access from a WED device. An Authorized Subscriber may similarly sign on to the E-Multi-Media Asset Sale System from an IPTV television set or a satellite television set and may then supply their unambiguous identity credentials.

Video Content Host Site applications may use authenticated Authorized Subscriber identity credentials to retrieve a list of Multi-Media Assets published to the Authorized Subscriber, by querying one or more Publisher/Subscriber databases for all Multi-Media Assets published to each authenticated unambiguous identity or each authenticated unambiguous identity alias specified by this Authorized Subscriber. An Authorized Subscriber may access any Multi-Media Asset that is published to any of his or her authenticated unambiguous identity credentials, subject to any publication terms-of-use conditions specified by the Publisher or imposed by the present E-Multi-Media Asset Sale System.

### Video Content Host Site (VCHS)

A Video Content Host Site (VCHS) is any data center that hosts the E-Multi-Media Asset Sale System elements located at that particular site. Such a data center may also host other applications not related to the present E-Multi-Media Asset Sale System. A single Video Content Host Site implementation may span all or part of a networked data center. If the Video Content Host Site facility spans multiple physical locations, the individual sites may or may not be co-located within the same geographic locale. The Video Content Host Site managing entity is called a Video Content Host Site operator. A cable, satellite or IPTV operator, or an Internet service provider or an online multi-media mass storage provider may be a Video Content Host Site operator. A cable, satellite or IPTV head-end or super head-end system, an Internet service provider or an online multi-media mass storage provider may function as a Video Content Host Site. A particular Video Content Host Site operator may own or operate multiple Video Content Host Sites.

Video Content Host Site network traffic may traverse the Video Content Host Site logical or physical Network Access Layer (NAL), which is a portal for Video Content Host Site multi-media communication network access. Network Access Layer services include public, semi-private and private network access. Public access includes public Internet access. Semi-private access includes inter-operator access, possibly via the Electronic Content Asset Gateway as described below. Private access may be limited to intra-operator access. The Network Access Layer may implement Electronic Content Asset Gateway data interchange facilities, e.g., protocol converters, transcoders, encoders and decoders, modulators and demodulators, multiplexers and demultiplexers, etc. E-Multi-Media Asset Sale System subscriber (Consumer) accounts may be hosted at a Video Content Host Site and may be stored in a computer database system. Subscriber account information may include, but is not limited to, the typical communications account data: subscriber name, billing address, phone number, E-mail address, and account payment information; E-Multi-Media Asset Sale System subscriber login name and password; list of E-Multi-Media Asset Sale System services to which the subscriber is authorized; subscriber's home Video Content Host Site; network location of the subscriber's Digital Video Content Recorders, Network Video Content Recorders, or streaming media servers or applications; metadata describing the subscriber's personal Multi-Media Assets stored at this Video Content Host Site; Multi-Media Asset storage and security policies; mass storage quota; configuration change history; security certificates; video processing results such as reports, charts, graphs, spreadsheets and data files; and so on.

Video Content Host Site mass storage or Digital Video Content Recorder mass storage may be allocated to one or more Video on Demand Libraries. This mass storage is accessible by Video Content Host Site or Digital Video Content Recorder video on demand transmission and streaming applications, application server computers, application software programs and multi-media communication network infrastructure. This mass storage may be located at the Video Content Host Site head-end, super head-end or multi-media content server facility or within a Digital Video Content Recorder and may be any suitable multi-media file storage media.

A Video on Demand Library may store Subscriber Assets, which are Multi-Media Asset files owned by subscribers. A Personal Video Archive thus comprises mass storage allocations and Multi-Media Asset files in one or more Video on Demand Libraries. A Personal Video Archive is called a Video on Demand Library, but this designation is merely shorthand for the underlying Personal Video Archive implementation. A Video on Demand Library may store Operator Assets, which are Multi-Media Asset files owned by Video Content Host Site operators. Operator Assets may also be stored in a Video on Demand Library residing on a Digital Video Content Recorder that is owned by an operator and located at a subscriber premises. A Video on Demand Library that exclusively stores Subscriber Assets is called a Subscriber Library. A Video on Demand Library that exclusively stores Operator Assets exclusively is called an Operator Library. A Video on Demand Library may contemporaneously store both Subscriber Assets and Operator Assets.

Conceptually, a Video on Demand Library is any data structure, abstract data type or object model comprising a Multi-Media Asset Catalog and a Multi-Media Asset Storage Facility. One or more Video on Demand Library instances may exist contemporaneously on Video Content Host Site mass storage or on Digital Video Content Recorder mass storage. Each Video on Demand Library instance may be accessible by name and may exist, for example, as or within one or more databases, file systems or custom software applications. Each Video on Demand Library Multi-Media Asset multi-media file is accessible, by name or otherwise, to the Video Content Host Site software applications or Digital Video Content Recorder software applications that must process it, such as video on demand transmission or streaming applications.

Multi-Media Asset multi-media files and Multi-Media Asset Metadata multi-media files stored in Video on Demand Libraries are called Distinct Assets. Identical copies of a Distinct Asset may exist contemporaneously within one or more Video on Demand Libraries. The E-Multi-Media Asset Sale System tracks ownership by a particular subscriber or operator for each Distinct Asset and may support ownership-related queries for Distinct Assets. Multi-Media Assets, Multi-Media Asset Metadata and Distinct Assets are also called Video on Demand Assets. A Video on Demand Library configuration may consist in a single Video on Demand Library instance containing Subscriber Assets and Operator Assets. A Video on Demand Library configuration called a Spanned Library consists in a Subscriber Library for each subscriber and one or more Operator Libraries. Other Video on Demand Library configurations are possible.

The Multi-Media Asset Catalog indexes the Multi-Media Asset multi-media file collection comprising a Video on Demand Library configuration. This multi-media file collection is stored in the Multi-Media Asset Storage Facility of this Video on Demand Library configuration. A Multi-Media Asset Catalog Entry stores a set of attributes for an Multi-Media Asset multi-media file as metadata that may include, but is not limited to, the Multi-Media Asset name, Multi-Media Asset multi-media file name, Multi-Media Asset type, Multi-Media Asset Identifier, Multi-Media Asset Multiplicity, Multi-Media Asset creation date, Multi-Media Asset Logical Delete Indicator, Multi-Media Asset last reference date, Multi-Media Asset owner, Multi-Media Asset access permissions, and the Multi-Media Asset File Location.

The ingest, upload, recording, copy, import, file transfer, archive, backup/restore, purchasing and leasing functions of Network Video Content Recorders, streaming media applications, Digital Content Video Recorders and Video Content Host Site application software programs, any of which may be provided by operators and which may be accessible by subscribers, create, write, update or store Multi-Media Asset multi-media files and Multi-Media Asset Metadata multi-media files in Subscriber Libraries or Operator Libraries. Any function that creates or stores Multi-Media Assets or Multi-Media Asset Metadata may implement an Asset Duplication Strategy. The Asset Duplication Strategy determines the number of identical copies of a Multi-Media Asset to be created or stored. Any function that stores Multi-Media Assets or Multi-Media Asset Metadata may implement an Asset Placement Strategy to select a Video on Demand Library instance for the new Distinct Asset. The Asset Placement Strategy selects a Video on Demand Library instance to store the Multi-Media Asset Catalog Entry and selects a Video on Demand Library instance to store the associated Distinct Asset multi-media file; the Asset Placement Strategy may select the same library in both cases, or it may select two different libraries. Further, for a Spanned Library configuration, the selected library instances may be Subscriber Libraries, Operator Libraries, or one of each depending on requirements. The search/playback and video on demand functions of Network Video Content Recorders, streaming media applications, Digital Content Video Recorders and Video Content Host Site application software programs, which may be accessible by subscribers, read or retrieve Multi-Media Asset multi-media files and Multi-Media Asset Metadata multi-media files stored in Subscriber Libraries or Operator Libraries. E-Multi-Media Asset Sale System video processing applications may analyze a subscriber's Personal Video Archive content and store the results in the subscriber's Personal Video Archive. Personal Video Archive content is organized or indexed by attributes such as Multi-Media Asset name, creation date and time, source (e.g., Digital Video Content Recorder, Network Video Content Recorder), camera identity, etc., and is indexed for random-access retrieval or video on demand retrieval by these attributes.

For each E-Multi-Media Asset Sale System subscriber account hosted at a particular Video Content Host Site, the Video Content Host Site operator may store the associated Personal Video Archive entirely at that site. If the Video Content Host Site operator owns or operates multiple Video Content Host Sites, the operator may disperse its Personal Video Archive mass storage over several Video Content Host Sites and store part of a subscriber's Personal Video Archive at one Video Content Host Site and the remainder at one or more other Video Content Host Sites. Similarly, the E-Multi-Media Asset Sale System subscriber account database mass storage may be centralized or distributed as the Video Content Host Site operator sees fit.

A Video Content Host Site operator may implement mass storage policies, typically including a quota system which indicates the maximum amount of Video Content Host Site Personal Video Archive mass storage a subscriber may allocate. The subscriber's current Personal Video Archive allocation may not exceed the quota. Personal Video Archive storage policies are rules that govern mass storage usage, including but not limited to, the length of time to retain a subscriber's stored Multi-Media Asset multi-media files; what to do when a subscriber's Personal Video Archive storage allocation reaches the quota; and so on. Storage policy examples include, but are not limited to, deleting the oldest stored Multi-Media Asset multi-media files to make room for new Multi-Media Asset multi-media files; automatically procuring additional Personal Video Archive capacity when the quota is reached, thereby dynamically establishing a new quota (“storage on demand”); and so on.

The Video Content Host Site subscriber access is typically web-based or network-based. A Video Content Host Site runs one or more web servers as portals to host subscriber logins and to serve GUI-WEB web pages. Subscribers and software applications may also access Video Content Host Site functions over the network via E-Multi-Media Asset Sale System GUIs and APIs. Video Content Host Site server computers host subscriber login sessions and Multi-Media Asset Publication System software applications launched by subscribers or operators, including but not limited to, one or more Network Video Content Recorders, streaming media applications, ingest applications, upload services, archive/retrieval operations, video processing applications, and so on. Other Video Content Host Site server software provides support for E-Multi-Media Asset Sale System GUI and API functions including, but not limited to, account management, streaming media applications, Multi-Media Asset creation, composition and publication, Electronic Content Asset Gateway, Personal Video Archive management, security policy administration and enforcement, and so on. Subscribers and operators use Network Video Content Recorders and streaming media applications to stream, or to record as subscriber Distinct Assets or operator Distinct Assets, the following content sources: network camera feeds, television programming, Digital Video Content Recorder network streams or any other content sources.

The essence of the Video Content Host Site is a centralized Multi-Media Asset repository; a centralized subscriber web portal; a centralized subscriber database and account administration function; a centralized control point for Multi-Media Asset and Multi-Media Asset Metadata creation, storage, processing and distribution; a platform for E-Multi-Media Asset Sale System software applications; a central control point for the Publisher/Subscriber Model; an Electronic Content Asset Gateway platform; a central control point for Network Video Content Recorders and streaming media servers and applications; a central control point for recording network camera streams, television programming and other content sources; and other functions explained herein. Further, as an IT datacenter, a Video Content Host Site has myriad physical and logical realizations.

The E-Multi-Media Asset Sale System uses various techniques at step 307 and elsewhere during operation to classify and index content and to organize Multi-Media Assets for subscriber search operations to supplement the Multi-Media Asset data or metadata provided by the Publisher. Subject classification and indexing is an important value-added service that helps subscribers efficiently and effectively navigate an enormous array of content, by maximizing the likelihood that the search results are compact and contain the desired item(s). Unlike textual content, which is trivially amenable to algorithmic classification methods, video content typically must be interpreted and classified manually or with specialized video analytics applications. The classification process involves reviewing content for various attributes or characteristics of interest, noting those that apply and loading classification databases with the resulting descriptive metadata. Subscribers may browse Multi-Media Asset collections by any of the stock classification categories provided by the E-Multi-Media Asset Sale System, or they may search the classification databases directly by posing ad hoc queries. Searches may return available titles and Multi-Media Asset Catalog Entry information such as the location of a Multi-Media Asset, which may reside inside (Multi-Media Asset Internal Location) or outside (Multi-Media Asset External Location) of the present E-Multi-Media Asset Sale System.

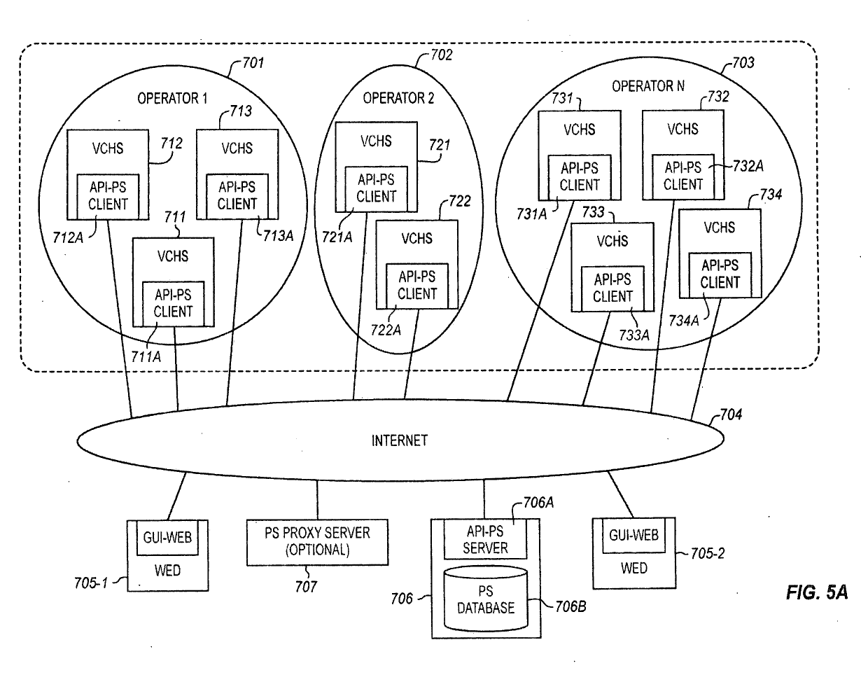

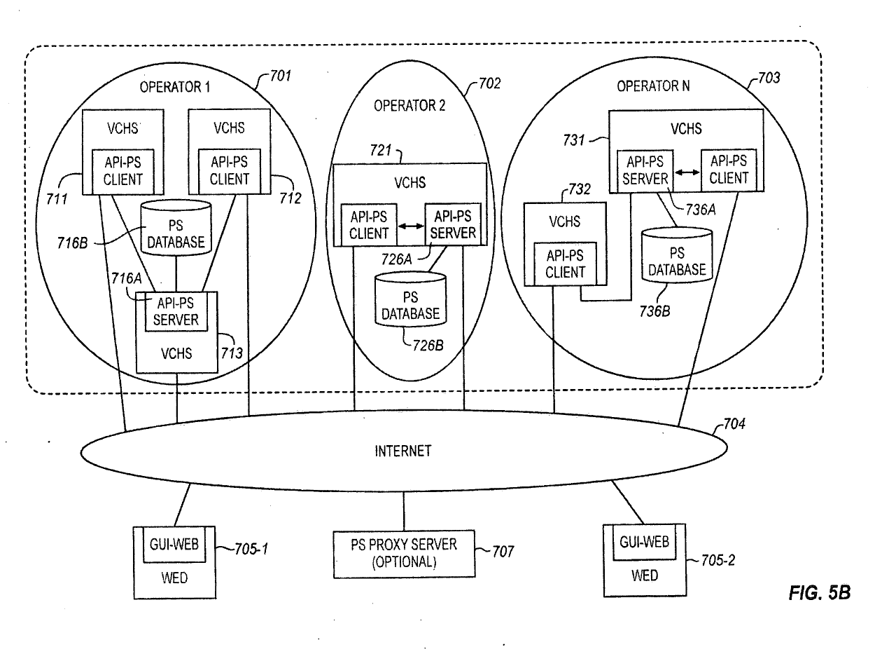

FIG. 5A illustrates, in block diagram form, a centralized Publisher/Subscriber database architecture where the database is shared among multiple operators. This figure illustrates three operators 701-703, each of which includes a plurality of Video Content Host Sites (711-713, 721-722, and 731-734, respectively) for the storage of Multi-Media Assets. FIG. 5B illustrates, in block diagram form, a distributed Publisher/Subscriber database architecture where the Publisher/Subscriber databases 716B, 726B, and 736B are shared via associated API-PS Servers 716A, 726A, and 736A among multiple operators. This figure illustrates three operators 701-703, each of which includes a plurality of Video Content Host Sites (711-713, 721, and 731-732, respectively) for the storage of Multi-Media Assets. A distributed Publisher/Subscriber database consists in the logical union of centralized Publisher/Subscriber databases belonging to all of the affiliated operators. Multiple Publisher/Subscriber databases 716B, 726B, and 736B may be for different purposes, e.g., one database for all subscriber video content and another for a multi-operator aggregate Video on Demand Library.

### Electronic Retail Value Chain Elements

FIG. 2 illustrates a simplified diagram of the present E-Multi-Media Asset Sale System 200. This section describes the electronic retail value chain elements and high level process flows of the present E-Multi-Media Asset Sale System 200. Separate entities, e.g., separate companies, may perform each of the following roles, or a single entity may perform two or more of these roles: Content Owner 201, Retail Operator 202, Storage Operator 204, or Multi-Media on Demand Operator 207. These entities may also conduct other business unrelated to the present E-Multi-Media Asset Sale System 200.

The APIs defined for the present E-Multi-Media Asset Sale System 200 clarify various API client-side and server-side roles and responsibilities and are especially convenient descriptions when one entity provides the API client support and another entity, e.g., a separate or autonomous business partner, provides the API server support. Any API described in this disclosure may be obviated, reduced or replaced through substitution when the same entity logically performs both the client-side and server-side API roles. For example, a cable operator may act as a Retail Operator 202 to electronically sell, lease, or register a collection of Multi-Media Assets that it holds in its own storage facility. This cable operator may also act as a Storage Operator 204 to provide Network-Based Consumer Multi-Media Libraries 205 for its Consumers. This cable operator may use its own methods to deposit a Multi-Media Asset, which was electronically purchased, leased, or registered by one of its Consumers, in a Network-Based Consumer Multi-Media Library 205 that is assigned to that Consumer 221 and resides in the cable operator's mass storage facility. This cable operator may also use its own methods to stream this Multi-Media Asset to the Consumer 221 on demand.

Any such electronic retail methods and process flows, any of which may be proprietary, are clearly recognized by those of ordinary skill in the art as logical equivalents of the methods and process flows of the present E-Multi-Media Asset Sale System 200, including methods defined by the APIs of the present E-Multi-Media Asset Sale System 200. Similarly, any user interface defined by the present E-Multi-Media Asset Sale System 200 may be replaced through substitution or may be incorporated by the provider's native user interface system, but such user interfaces are clearly recognized by those of ordinary skill in the art as logical equivalents of the user interfaces of the present E-Multi-Media Asset Sale System 200.

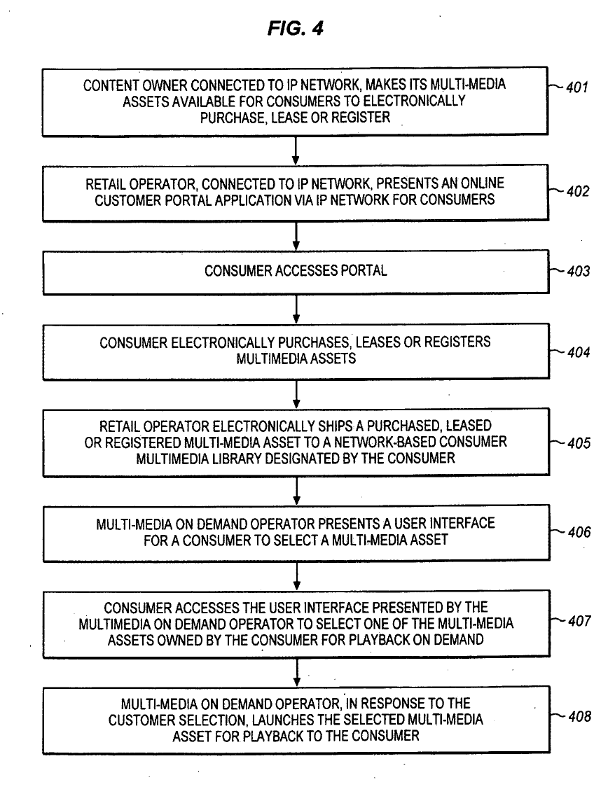

FIG. 4 illustrates, in flow diagram form, the operation of the present E-Multi-Media Asset Sale System 200. An outline of the basic process flow of the entire system is as follows. A Content Owner 201, connected to the communication medium noted as IP Network 211, makes its Multi-Media Assets (not shown) available at step 401 for Consumers 221 and 222 to electronically purchase, lease, or register. A Retail Operator 202, connected to the communication medium noted as IP Network 211, at step 402 presents an online customer portal application via IP Network 211 for Consumers 221 and 222 to electronically purchase, lease or register these Multi-Media Assets at step 403. The Retail Operator 201, in response to the Consumer 221 purchasing, leasing, or registering one or more selected Multi-Media Assets at step 404, electronically ships each purchased, leased, or registered Multi-Media Asset at step 405 to a Network-Based Consumer Multi-Media Library 205 that is designated by the Consumer 221. A Network-Based Consumer Multi-Media Library 205 is provided by a Storage Operator 204 that typically implements multiple Network-Based Consumer Multi-Media Libraries for the storage of Multi-Media Assets for the associated Consumers 221 and 222. Multi-Media Assets stored in a Network-Based Consumer Multi-Media Library 205 are accessible to a Multi-Media on Demand (MMoD) Operator 207. A Multi-Media on Demand Operator 207 at step 406 presents a user interface for a Consumer 221 to select a Multi-Media Asset. This is accomplished at step 407 when the Consumer 221 accesses the user interface presented by the Multi-Media on Demand Operator 207 to select one of the Multi-Media Assets owned by or accessible to the Consumer 221 for playback on demand. A Multi-Media on Demand Operator 207, in response to the Consumer selection, launches the selected Multi-Media Asset for playback to the Consumer 221 at step 408 in response to the Consumer 221 selecting a particular Multi-Media Asset. A Consumer 221 that purchased a Multi-Media Asset on physical media such as a DVD may alternatively register that purchase with a Retail Operator 202 to obtain an online copy of the Multi-Media Asset in a Network-Based Consumer Multi-Media Library 205, just as if the Consumer 221 had purchased the Multi-Media Asset online.

### Content Owner

A Content Owner 201 may collaborate with a Retail Operator 202 to electronically sell, lease or register its Multi-Media Assets to online Consumers 221 and 222. A Content Owner 201 may authorize the Retail Operator 202 to store these Multi-Media Assets in its online merchandise inventory; and may specify the Consumer terms and conditions of each sale, lease, or registration; and may specify terms and conditions for other electronic retail value chain elements that may interact with the Retail Operator 202, including Storage Operators 204 or Multi-Media on Demand Operators 207. A Content Owner 201 may furnish the Retail Operator 202 with at least one copy of each Multi-Media Asset to be electronically sold, leased, or registered, including any variants encoded in different formats, e.g., standard definition (SD), high definition (HD), etc. A Content Owner 201 may also define the Multi-Media Asset Entitlement format for each Multi-Media Asset that Consumers 221 and 222 may register electronically. In the E-Multi-Media Asset Sale System 200, a Content Owner 201 may also specify rules governing content ubiquity for purchased, leased or registered Multi-Media Assets including Publisher/Subscriber sharing or republication restrictions, allowable devices for viewing and other rules or terms related to Multi-Media Asset usage in the E-Multi-Media Asset Sale System 200.

### Retail Operator

A Retail Operator 202 is an e-commerce business that operates one or more online retail outlets, e.g., Internet web sites. A Retail Operator 202 may own and operate every element of its operations, or it may subcontract any of these elements, e.g., customer account management or online payment services. For example, Amazon.com may function as a Retail Operator 202 and may subcontract PayPal.com to receive online payments.

A Retail Operator 202 may receive a Multi-Media Asset inventory from each Content Owner 201 that it conducts business with, or from other sources. The Retail Operator 202 stores this Multi-Media Asset inventory on any suitable digital mass storage media. A Storage Operator 204 and/or 206 may host the storage for this inventory in a Retail Operator Library. The Retail Operator 202 must store at least one copy of each Multi-Media Asset inventoried for sale or lease, including any required variants of each Asset such as standard definition (SD) or high definition (HD) formats, etc.

A Retail Operator 202 provides an online customer interface for Consumers 221 and 222 to browse or search the Multi-Media Asset inventory and to purchase, lease or register Multi-Media Assets. For leased Multi-Media Assets, the Retail Operator 202 may assign the lease terms, including the lease duration, and may give the Consumers 221 and 222 the option to adjust the lease terms or duration.

The order fulfillment process requires the Consumers 221 and 222 to designate an Electronic Shipping Address for each Multi-Media Asset purchased, leased or registered. An Electronic Shipping Address denotes a Network-Based Consumer Multi-Media Library 205 held by a Storage Operator 204 for Consumer 221, which Library could be shared in whole or part with Consumer 222 (such as family members having individual libraries with the parents having universal access). An Electronic Shipping Address may comprise a username, password, E-mail address, Storage Operator 204 identity, account number, name of a Network-Based Consumer Multi-Media Library 205, or any other information. The order fulfillment process may interact with the designated Storage Operator 204 via the Retail API for each Multi-Media Asset listed on the Bill of Sale, to validate the Electronic Shipping Address for each Multi-Media Asset.

A Network-Based Consumer Multi-Media Library 205 must have sufficient unused capacity to store any purchased, leased, or registered Multi-Media Asset or Multi-Media Asset Entitlement that is electronically shipped to it. The order fulfillment process may interact with the Storage Operator 204 via the Retail API to verify sufficient storage capacity exists prior to completing the sale. The order fulfillment process may advise the Consumers 221 and 222 when a Multi-Media Asset or Multi-Media Asset Entitlement is undeliverable due to insufficient storage capacity in the Network-Based Consumer Multi-Media Library 205, and it may remove undeliverable items from the Bill of Sale before completing the sale; or it may warn the Consumer 221 that insufficient space exists and ship the Multi-Media Asset or Multi-Media Asset Entitlement to the Storage Operator 204 to be held for delivery until Consumer 221 has provisioned sufficient storage space in the Network-Based Consumer Multi-Media Library 205, whereupon the Storage Operator 204 releases the hold and delivers the Multi-Media Asset or Multi-Media Asset Entitlement to the Network-Based Consumer Multi-Media Library 205. The order fulfillment process may send the finalized Bill of Sale to Consumer 221 at any time before, during, or after the electronic shipping process has concluded.

For each Multi-Media Asset electronically purchased, leased, or registered, the Retail Operator 202 electronically ships the Multi-Media Asset or an associated Multi-Media Asset Entitlement to the designated Storage Operator 204. Electronic shipping methods may include the Internet, HTTP, FTP, local or remote file copy operation, customized Multi-Media Asset delivery software, or any other computerized delivery methods. Multi-Media Assets shipped electronically are shipped from the Retail Operator's Multi-Media Asset inventory or from some other source. Electronic shipments may occur immediately or on a scheduled basis. Multi-Media Asset lease terms, which may include ownership and right-to-use terms, are electronically shipped with each leased Multi-Media Asset. In the E-Multi-Media Asset Sale System 200, Multi-Media Asset lease terms may also specify rules governing content ubiquity for a leased Multi-Media Asset including Publisher/Subscriber sharing or republication restrictions, allowable devices for viewing and other rules or terms governing leased Multi-Media Asset usage in the E-Multi-Media Asset Sale System 200.

The electronic shipping process may interact with the Storage Operator 204 via the Retail API to determine whether to ship a Multi-Media Asset versus a Multi-Media Asset Entitlement. If the Storage Operator 204 already holds a suitable copy of the Multi-Media Asset, shipping a Multi-Media Asset Entitlement instead of the Multi-Media Asset will avoid burdening the Storage Operator 204 with multiple identical copies of the same Multi-Media Asset. The Retail Operator 202 composes a Multi-Media Asset Entitlement in the format specified by the Content Owner 201 or in a format accepted by the Storage Operator 204.

In the special case where the Retail Operator 202 and the Storage Operator 204 are the same entity, e.g., a cable operator, the electronic shipping process may be simplified considerably and may, for example, consist in the cable operator using a simple file copy operation to create a copy of the purchased, leased, or registered Multi-Media Asset or a Multi-Media Asset Entitlement in the designated Network-Based Consumer Multi-Media Library 205, along with the Multi-Media Asset lease terms, if applicable.

### Consumer

Consumers 221 and 222 electronically purchase, lease or register a Multi-Media Asset via a Retail Operator 202 and specify an Electronic Shipping Address for that Multi-Media Asset. The Retail Operator 202 ships the purchased, leased or registered Multi-Media Asset to a designated Network-Based Consumer Multi-Media Library 205 at the specified Electronic Shipping Address; the Network-Based Consumer Multi-Media Library 205 is provided by a Storage Operator 204. Consumers 221 and 222 may have accounts registered with multiple Storage Operators 204 and 206. Consumers 221 and 222 may use an online Consumer Storage Interface to perform Storage Operator account management functions. Consumers 221 and 222 may use a Consumer Multi-Media on Demand Interface provided by Multi-Media on Demand Operator 207 to select a Multi-Media Asset from a Network-Based Consumer Multi-Media Library 205 for playback on demand. The Multi-Media on Demand Operator 207 may access the Network-Based Consumer Multi-Media Library 205 and may stream the selected Multi-Media Asset to Consumers 221 and 222 for viewing. Consumers 221 and 222 may view a leased Multi-Media Asset on demand during the leasing period in accordance with the lease terms.

A Content Owner 201 or other source may retail its Multi-Media Assets to Consumers 221 and 222 on physical media, e.g., in DVD format, and may include with each physical Multi-Media Asset sold a license certificate or other conveyance containing a key value that uniquely identifies the particular Multi-Media Asset copy, e.g., a Multi-Media Asset title combined with a manufacturer's serial number, or a Multi-Media Asset Identifier, or any other suitable key value format. Keys may be encoded or encrypted to thwart forgeries. Consumers 221 and 222 may register this key online to have an electronic version of the Multi-Media Asset deposited in a designated Network-Based Consumer Multi-Media Library 205, just as if Consumers 221 and 222 had electronically purchased the Multi-Media Asset online.

While many different Multi-Media Asset registration processes are possible, the preferred process is as follows. Consumers 221 and 222 locate a Retail Operator 202 that can register the Multi-Media Asset; such a Retail Operator 202 holds the corresponding Multi-Media Asset in its Multi-Media Asset inventory or can temporarily access or acquire a copy of the requested Multi-Media Asset to complete the registration process. Consumers 221 and 222 use the Retail Operator 202 online customer interface to access the Multi-Media Asset registration process. Consumers 221 and 222 supply the Multi-Media Asset key, an Electronic Shipping Address, and any other information requested by the Retail Operator 202. The Retail Operator 202 collaborates with an authoritative source via a Key Registration API to definitively validate the key and universally verify the key is eligible for registration; details are beyond the scope of the present E-Multi-Media Asset Sale System 200. The authoritative source may be the Content Owner 201 of this Multi-Media Asset, an entity authorized by the Content Owner 201, or some other source. If the key is eligible for registration, the authoritative source may permanently or universally register the key in the Consumer's name and grants the Retail Operator 202 permission to electronically ship the Multi-Media Asset to the Electronic Shipping Address provided by Consumers 221 and 222; otherwise, the registration request is rejected. After the key is registered, the Retail Operator 202 may complete the Multi-Media Asset registration process by invoking the order fulfillment and electronic shipping processes just as if Consumers 221 and 222 had electronically purchased the Multi-Media Asset online.

In the E-Multi-Media Asset Sale System 200, Consumers 221 and 222 may have additional capabilities including Publisher/Subscriber capabilities for multi-media content ubiquity, whereby Consumers 221 and 222 may grant or receive access to view Multi-Media Assets held by other Consumers 221 and 222.

### Storage Operator

A Storage Operator 204 provides long-term Multi-Media Asset Storage for Multi-Media Assets electronically purchased, leased or registered by Consumers 221 and 222. A Storage Operator 204 provides an account and one or more Network-Based Consumer Multi-Media Libraries 205 to Consumers 221 and 222 that it hosts. A Storage Operator 204 may assign a quota limiting the storage capacity of each Network-Based Consumer Multi-Media Library 205 or limiting the total storage capacity of all Network-Based Consumer Multi-Media Libraries 205 held by Consumers 221 and 222. A Storage Operator 204 may bill Consumers 221 and 222 periodically for storage allocation or storage utilization.

A Storage Operator 204 may provide an online Consumer Storage Interface for Consumers 221 and 222 to perform account management, e.g., update billing information; increase or decrease storage quotas; define policies for managing Network-Based Consumer Multi-Media Library content or mass storage allocation when the current storage utilization reaches a quota, e.g., delete or archive the least recently used Multi-Media Assets or the oldest Multi-Media Assets; automatically purchase additional space incrementally; and other account management functions as required. The presentation and functionality of the Consumer Storage Interface is beyond the scope of the present E-Multi-Media Asset Sale System 200 and need not be identical for all Storage Operators 204.

A Storage Operator 204 holds Consumer Multi-Media Assets in a logical container called a Network-Based Consumer Multi-Media Library 205. This construct may take many different forms and is described here in purely illustrative terms. Quite generally, a Network-Based Consumer Multi-Media Library 205 comprises a Multi-Media Asset Catalog 205A and a persistent Multi-Media Asset Storage Facility 205B. The Multi-Media Asset Catalog 205A is an index system comprising Multi-Media Asset Catalog Entries and supporting Multi-Media Asset storage and retrieval by name. The Multi-Media Asset Storage Facility 205B holds the digital Multi-Media Asset files deposited in the Network-Based Consumer Multi-Media Library 205.

A Network-Based Consumer Multi-Media Library 205 may be stored in a file system, database, custom software application, or any other suitable facility. Each Multi-Media Asset Catalog 205A Multi-Media Asset Catalog Entry in a Network-Based Consumer Multi-Media Library 205 describes a Multi-Media Asset held in the Multi-Media Asset Storage Facility 205B of that Network-Based Consumer Multi-Media Library 205 and provides a means to access that Multi-Media Asset, for example to perform playback on demand. Consumers may inspect and manage Multi-Media Assets stored in the Network-Based Consumer Multi-Media Library 205 via the Consumer Storage Interface. A Storage Operator 204 may hold or access Multi-Media Assets in one or more Storage Operator Libraries, and a Storage Operator 204 may store the Multi-Media Asset inventory for a Retail Operator 202 in a Retail Operator Library. The Storage Operator Library construct and the Retail Operator Library construct may be identical to the Network-Based Consumer Multi-Media Library construct.

A Storage Operator 204 may provide server-side support for two different network APIs. The Retail API supports the Retail Operator 204 order fulfillment and electronic shipping processes; and the Multi-Media on Demand API supports the Multi-Media on Demand Operator 207 On-Demand Multi-Media Asset Delivery process. A suitable high-speed network architecture and network infrastructure interconnects Consumers 221 and 222, Retail Operators 202, Storage Operators 204 and 206, and Multi-Media on Demand Operators 207 and may incorporate the public Internet, semi-private or private networks, or a combination of these or any other network types. Network and API standards and protocols are determined by requirements and may support secure or encrypted network communications.

Storage Operator 204 support for the Retail API may include capabilities to validate a Consumer 221 and 222 storage account; verify sufficient unused Network-Based Consumer Multi-Media Library 205 storage capacity to receive an electronically-shipped Multi-Media Asset; determine whether a Multi-Media Asset Entitlement may be shipped instead of an Multi-Media Asset; receive a Multi-Media Asset or Multi-Media Asset Entitlement shipment; catalog a newly received Multi-Media Asset in a designated Network-Based Consumer Multi-Media Library 205; electronically deposit a Multi-Media Asset file in the Multi-Media Asset Storage Facility 205B of a designated Network-Based Consumer Multi-Media Library 205; and other capabilities consistent with the order fulfillment and electronic shipping processes.

A Storage Operator 204 may support multiple Multi-Media Asset Entitlement formats. Upon receiving a Multi-Media Asset Entitlement from a Retail Operator 202, a Storage Operator 204 may store a copy of the associated Multi-Media Asset in the designated Network-Based Consumer Multi-Media Library 205. The source for this copy may be an identical Multi-Media Asset held in another Network-Based Consumer Multi-Media Library 205, a Storage Operator Library or a Retail Operator Library. Alternatively, to avoid mass storage proliferation, the Storage Operator 204 may initialize the Multi-Media Asset Catalog 205A Multi-Media Asset Catalog Entry for a Multi-Media Asset Entitlement as a synonym, e.g., a pointer, link, or alias, for an identical Multi-Media Asset copy held in another Network-Based Consumer Multi-Media Library 205, a Storage Operator Library or a Retail Operator Library. A synonym construct consumes only a trivial amount of storage space compared to a Multi-Media Asset file. Further, a Storage Operator 204 may implement storage optimization techniques to improve mass storage efficiencies. The Storage Operator 204 may delete each leased Multi-Media Asset from its associated Network-Based Consumer Multi-Media Library 205 immediately upon lease expiration.

Storage Operator 204 support for the Multi-Media on Demand API may include capabilities to authenticate a Multi-Media on Demand Operator 207; validate a Multi-Media on Demand Operator 207 request; access a designated Network-Based Consumer Multi-Media Library 205; list the contents of a Network-Based Consumer Multi-Media Library 205; obtain Multi-Media Asset properties or characteristics; read a Multi-Media Asset file over the network 211; launch a playback stream for a specified Multi-Media Asset; process Multi-Media Asset playback trick modes; transfer a Multi-Media Asset copy to a Multi-Media on Demand Operator 207; and other capabilities consistent with the On-Demand Multi-Media Asset Delivery process. In the E-Multi-Media Asset Sale System 200, a Storage Operator 204 may implement the Publisher/Subscriber content ubiquity model for sharing Multi-Media Assets among Consumers 221 and 222, and the Electronic Content Asset Gateway for Multi-Media on Demand Operators 207.

### Multi-Media on Demand Operator

A Multi-Media on Demand Operator 207 may implement one or more Consumer Multi-Media on Demand Interfaces for Consumers 221 and 222 to playback Multi-Media Assets on demand. Such an interface may be an on-screen interactive program guide (IPG) provided by a set-top box or equivalent television receiver; an online user interface, e.g., a web-based interface; or any other suitable interface. Interface presentation and navigation details are beyond the scope of the present E-Multi-Media Asset Sale System 200 and need not be identical for all Multi-Media on Demand Operators 207. In the E-Multi-Media Asset Sale System 200, a Consumer Multi-Media on Demand Interface may be implemented as GUI-IPG, GUI-WEB or GUI-WED.

The Consumer Multi-Media on Demand Interface allows Consumers 221 and 222 to identify their Storage Operators 204 and 206 and Network-Based Consumer Multi-Media Libraries 205, e.g., by selecting from a list of popular Storage Operators 204 and 206, or by inputting Storage Operator account information from a virtual or physical keyboard, or by other means. Consumers 221 and 222 with multiple Storage Operator accounts may define each account via this interface. Similarly, Consumers 221 and 222 may identify any or all Network-Based Consumer Multi-Media Libraries 205 associated with each Storage Operator account.

A Multi-Media on Demand Operator 207 may store Storage Operator account information and Network-Based Consumer Multi-Media Library 205 account information provided by each Consumer 221 and 222 in a persistent Consumer Profile. A Multi-Media on Demand Operator 207 may use a Consumer Profile to locate and display the Multi-Media Assets the Consumers 221 and 222 may playback or access on demand, e.g., by issuing Multi-Media on Demand API calls to each Storage Operator 204 listed in the Consumer Profile to obtain the Multi-Media Asset titles held in the Network-Based Consumer Multi-Media Libraries 205 listed in the Consumer Profile. Consumers 221 and 222 may use a Consumer Multi-Media on Demand Interface to browse these Multi-Media Assets and select a Multi-Media Asset for playback on demand.

When Consumers 221 and 222 select a Multi-Media Asset for playback, the Multi-Media on Demand Operator 207 may interact with the associated Storage Operator 204 to execute the On-Demand Multi-Media Asset Delivery process. This process may invoke the Multi-Media on Demand API to perform one or more functions between the Multi-Media on Demand Operator 207 and the Storage Operator 204 such as user authentication; Multi-Media Asset verification or validation, e.g. to verify compatible Multi-Media Asset recording format or encoding; download a Multi-Media Asset for playback; open a Multi-Media Asset file for reading over the network; launch a Multi-Media Asset playback stream; etc. Ultimately, the Multi-Media on Demand Operator 207 will use its multi-media on demand transmission methods and facilities, which may be proprietary, to stream the requested Multi-Media Asset for Consumer viewing. A Multi-Media on Demand Operator 207 may enhance its On-Demand Multi-Media Asset Delivery process by implementing E-Multi-Media Asset Sale System 200 content ubiquity techniques including the Publisher/Subscriber model and the Electronic Content Asset Gateway.

### SUMMARY

The system for electronic retail sales of multi-media assets operates as an overlay application on existing multi-media communication networks to receive individual consumer purchase requests for a selected multi-media asset and deliver a copy of that multi-media asset to the consumer's designated online personal storage space, which represents a network-based consumer multi-media library.

What is claimed as new and desired to be protected by Letters Patent of the United States is:

1. An electronic retail sales of multi-media assets system, operable in a communication network, for providing electronic content on demand to selected consumers, comprising:
multi-media asset source means for providing a plurality of multi-media assets and multi-media asset entitlements, each multi-media asset entitlement comprising a digital certificate that uniquely identifies said consumer and an associated multi-media asset, for sale to consumers;
network-based consumer multi-media library means for storing a consumer's multi-media assets and multi-media asset entitlements for access by said consumer; and
multi-media asset sale means, responsive to said consumer purchasing a multi-media asset or a multi-media asset entitlement from said multi-media asset source means, for transferring said purchased multi-media asset or multi-media asset entitlement to said network-based consumer multi-media library means.

2. The electronic retail sales of multi-media assets of claim 1, further comprising:
Multi-Media on Demand Operator means, responsive to a consumer requesting, via a consumer terminal device, access to a selected one of said consumer's Multi-Media Assets, for streaming said selected Multi-Media Asset from said network-based consumer multi-media library means to said consumer terminal device.

3. The electronic retail sales of multi-media assets of claim 2 wherein said Multi-Media on Demand Operator means comprises:
authentication means, responsive to said consumer accessing said Multi-Media on Demand Operator means, for validating an identity of said consumer and authorization of said consumer to access said Multi-Media on Demand Operator means.

4. The electronic retail sales of multi-media assets of claim 1, further comprising:
publication rules means for storing data received from an originator of a Multi-Media Asset which define a set of Multi-Media Asset publication rules.

5. The electronic retail sales of multi-media assets of claim 4 wherein said Multi-Media Asset publication rules comprise: authorized consumers, Multi-Media Asset availability schedules, allowable mediums for publication of an associated Multi-Media Asset, allowable device types for the display of an associated Multi-Media Asset, authorized destinations, Multi-Media Asset storage management, expiration date of an associated Multi-Media Asset, and Multi-Media Asset composition and layout.

6. The electronic retail sales of multi-media assets of claim 5, further comprising:
publishing means for providing a Multi-Media Asset, originated by a Multi-Media Asset originating individual, in a location which is accessible by at least one authorized consumer.

7. The electronic retail sales of multi-media assets of claim 1, further comprising:
publisher/subscriber database means for storing data received from said originator of said Multi-Media Asset indicative of at least one consumer authorized to access said Multi-Media Asset.

8. The electronic retail sales of multi-media assets of claim 7, further comprising:
content request means, responsive to a consumer requesting access to a selected Multi-Media Asset, for determining whether said requesting consumer is one of said at least one consumer specified by said originator of said Multi-Media Asset.

9. The electronic retail sales of multi-media assets of claim 1, further comprising:
medium means for determining a medium on which to transmit said requested Multi-Media Asset to said requesting consumer.

10. The electronic retail sales of multi-media assets of claim 1, further comprising:
delivery means for transmitting said requested Multi-Media Asset to said requesting consumer on said determined medium.

11. The electronic retail sales of multi-media assets of claim 1, further comprising:
multi-media asset source means to inventory only a single copy of each Multi-Media Asset including each of its variants.

12. The electronic retail sales of multi-media assets of claim 1, further comprising:
storage operator means for managing said network-based consumer multi-media library means to provide an interface for consumers to access their multi-media assets and multi-media asset entitlements stored in said network-based consumer multi-media library means.

13. The electronic retail sales of multi-media assets of claim 12 wherein said multi-media asset sale means is responsive to an Electronic Shipping Address received from said consumer which identifies said network-based consumer multi-media library means.

14. A method of operating electronic retail sales of multi-media assets system, operable in a communication network, for providing electronic content on demand to selected consumers, comprising:
providing a source of multi-media assets and multi-media asset entitlements, each multi-media asset entitlement comprising a digital certificate that uniquely identifies said consumer and an associated multi-media asset, for sale to consumers;
storing, in a network-based consumer multi-media library, a consumer's multi-media assets and multi-media asset entitlements for access by said consumer; and
transferring, in response to said consumer purchasing a multi-media asset or a multi-media asset entitlement from said multi-media asset source, said purchased multi-media asset or multi-media asset entitlement to said network-based consumer multi-media library.

15. The electronic retail sales of multi-media assets of claim 14, further comprising:
streaming, in response to a consumer requesting, via a consumer terminal device which accesses a Multi-Media Asset server a selected one of said consumer's Multi-Media Assets, said selected Multi-Media Asset from said network-based consumer multi-media library to said consumer terminal device.

16. The electronic retail sales of multi-media assets of claim 15 wherein said step of streaming comprises:
validating, in response to said consumer accessing said Multi-Media on Demand Operator means, an identity of said consumer and authorization of said consumer to access said Multi-Media Asset server.

17. The electronic retail sales of multi-media assets of claim 14, further comprising:
storing data received from an originator of a Multi-Media Asset which define a set of Multi-Media Asset publication rules.

18. The electronic retail sales of multi-media assets of claim 17 wherein said Multi-Media Asset publication rules comprise: authorized consumers, Multi-Media Asset availability schedules, allowable mediums for publication of an associated Multi-Media Asset, allowable device types for the display of an associated Multi-Media Asset, authorized destinations, Multi-Media Asset storage management, expiration date of an associated Multi-Media Asset, and Multi-Media Asset composition and layout.

19. The electronic retail sales of multi-media assets of claim 18, further comprising:
providing a Multi-Media Asset, originated by a Multi-Media Asset originating individual, in a location which is accessible by at least one authorized consumer.

20. The electronic retail sales of multi-media assets of claim 14, further comprising:
storing publisher data received from said originator of said Multi-Media Asset indicative of at least one consumer authorized to access said Multi-Media Asset.

21. The electronic retail sales of multi-media assets of claim 20, further comprising:
determining, in response to a consumer requesting access to a selected Multi-Media Asset, whether said requesting consumer is one of said at least one consumer specified by said originator of said Multi-Media Asset.

22. The electronic retail sales of multi-media assets of claim 14, further comprising:
determining a medium on which to transmit said requested Multi-Media Asset to said requesting consumer.

23. The electronic retail sales of multi-media assets of claim 14, further comprising:
transmitting said requested Multi-Media Asset to said requesting consumer on said determined medium.

24. The electronic retail sales of multi-media assets of claim 14, further comprising:
inventorying only a single copy of each Multi-Media Asset including each of its variants.

25. The electronic retail sales of multi-media assets of claim 14, further comprising:
managing said network-based consumer multi-media library to provide an interface for consumers to access their multi-media assets and multi-media asset entitlements stored in said network-based consumer multi-media library.

26. The electronic retail sales of multi-media assets of claim 25 wherein said step of transferring is responsive to an Electronic Shipping Address received from said consumer which identifies said network-based consumer multi-media library.
